(19) United States
(12) Patent Application Publication
(10) Pub. No.: US 2021/0005108 A1
(43) Pub. Date: Jan. 7, 2021

(54) INTERACTIVE LANGUAGE LEARNING FROM AN AUDIO RECORDING

(71) Applicant: UNIVOICE CORPORATION, Temple, TX (US)

(72) Inventor: Sami Halabi, Temple, TX (US)

(21) Appl. No.: 16/813,623

(22) Filed: Mar. 9, 2020

Related U.S. Application Data
(60) Provisional application No. 62/815,960, filed on Mar. 8, 2019.

(51) Int. Cl. G09B 19/06; G09B 5/06; G10L 15/00

(52) U.S. Cl. CPC G09B 19/06; G10L 15/005; G09B 5/06

(57) ABSTRACT

The present invention relates to an interactive language learning system from an audio recording, such as a musical composition. The system is configured to assist the user in achieving proficiency in pronouncing words in desired foreign language by repeating after the lyrics of the musical composition in an as-instructed manner. The system is further equipped to evaluate performance of user in terms of contextual understanding of the language and pronunciation of each word real time.

The present application claims the benefit of U.S. Provisional Application No. 62/815,960 filed Mar. 8, 2019; all of which is incorporated by reference herein.

### FIELD OF INVENTION

The present invention is directed to a computer assisted system for interactive language learning, and more particularly for assisting the user in learning plurality of new, non-native languages from an audio recording in real time.

### BACKGROUND OF INVENTION

Conventionally known solutions of language learning are primarily directed towards organizing a foreign language tutor for a classroom session, or making his content available over a network for one or more end users. As will be generally agreed upon that attending lectures of the trainer within a class room has always been an expensive and a time consuming process, similarly getting trained over on online session usually remains a one-sided affair with limited understanding of end user's progress.

In addition, the user is not guided in real time about the correctness of his pronunciation of words in a foreign language, the literal meaning of such words or their contextual usage when taught over an online session. Further, the learning is limited to attending one language at a time. The user is expected to enroll again or register and pay additional amount if he desires to opt for any other language. Sometimes, it may be so that the user is interested in learning more than language at one time or he wishes to draw a commonality between two closely related languages.

There are many languages of same family that may have multiple similar grammatical features and key words, especially older words sharing a common origin. For example, languages such as Gaelic, French, Spanish, Portuguese, Italian are linguistically similar and while training in either of these languages, the user may wish to relate and thereby understand, if not fully but partially, any of other closely related language. Now, the user may not be interested in registering separately for such language and incurring additional expenses making the overall language learning session a lengthy, exhaustive and a cumbersome task.

Moreover, the motivation for learning a foreign language usually takes a deep dive when a traditional class-room kind of schedule and set up is established. While listening to any lecture in a same, boring and monotonous way is a tedious process, it also has been proven ineffective when these sessions go on for extended period of time. The concentration of user may get drifted and he may not able to bring his learning ability on track if he has missed out any linking and prominent part of the lecture.

Hence, in the background of foregoing limitations, there exists a need for an easy, cost-effective and play way system for language learning that not only makes the learning process entertaining for user, but interactive as well in real time.

A primary objective of the present disclosure is to provide an easy, play way system for learning a foreign or target language from a musical composition.

In one other objective of the present disclosure, an interactive language learning system for training the user to speak and pronounce words in a foreign language appropriately, is provided.

Another objective of the present disclosure is to standardize the method of scoring the user for correctly and accurately pronouncing the words spoken in foreign language such that motivation to perform better and best sustains.

In yet another objective of the present disclosure, the user is provided a practical training in real time to learn, understand and imitate usage of foreign language skillfully with continued motivation.

In still other object of present disclosure, a personalized, cost-effective language learning session is organized for an end user for effective development of his grip on a foreign language.

### BRIEF DESCRIPTION OF THE DRAWINGS

FIG. 1 is block diagram illustrating the language learning system, in accordance with one embodiment of present disclosure.

FIG. 2 is a snapshot of web application framework, in accordance with one embodiment of present disclosure.

FIG. 3 is a snapshot of user management area, in accordance with one embodiment of present disclosure.

FIG. 4 is a snapshot of genre management area, in accordance with one embodiment of present disclosure.

FIG. 5 is a snapshot of song management area, in accordance with one embodiment of present disclosure.

FIG. 6 is a snapshot of content management area, in accordance with one embodiment of present disclosure.

FIG. 7 is a snapshot of feedback tab, in accordance with one embodiment of present disclosure.

### DETAILED DESCRIPTION OF THE EMBODIMENTS

Before the present working principle of an interactive language learning system is described, it is to be understood that this disclosure is not limited to the particular system for achieving so, as described, since it may vary within the specification indicated. Numerous processes and functions for assisting users in learning new language from an audio recording may be provided by introducing variations within the components/subcomponents disclosed herein. It is also to be understood that the terminology used in the description is for the purpose of describing the particular versions or embodiments only, and is not intended to limit the scope of the present invention, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The present disclosure envisages a detailed and descriptive system for interactive language learning from an audio recording, preferably a music composition containing lyrics and other accompaniments such as text or sound. The solution proposes to evade from an old school mode of language learning that makes the session boring. Rather, the intent is to create user's continued interest by enabling user to engage in singing and thereafter adding words to his vocabulary based on his understanding of word's contextual usage within one or more songs.

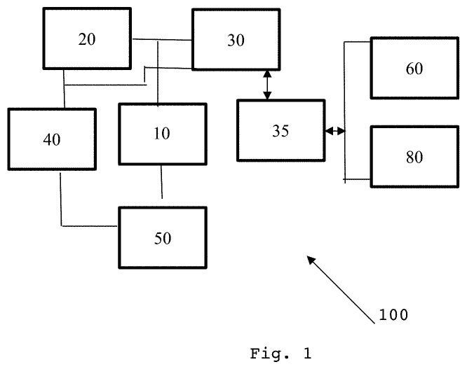

In one working embodiment of present disclosure, a computer assisted system for learning language from any audio file recorded in the digitized format, is presented. In one instance, this audio file may be a musical composition in any given language, a user is acquainted with. FIG. 1 is a block diagram of a language learning system 100 in accordance with first embodiment of present disclosure. As illustrated, the language learning system 100 comprises of a control unit 10, an input unit 20, a memory 30, a communication unit 40, and a display unit 50.

The control unit 10 is configured to control overall processing of program instructions stored in memory 30 for enabling language learning by the end user during his interaction with the system 100 via display unit 50 over a communication unit 40. Re-referring to FIG. 1, the content of an audio file at first goes as a feed to the language learning system 100 via the input unit 10, which may for example be a mouse or a touch interface. The language learning system 100 comprises of a local reference library 35 associated with memory 30 that is capable of recording a speech as an audio file. In one exemplary embodiment, SWIFT language class library for IOS platform and Android Studio for Android platform is maintained.

In one working embodiment, a variable may be added to the reference library 35 for the purposes of specifying different languages such as Spanish, French, English, Hindi etc. Now, from the given set of languages, the user makes a selection of the preferred language he is desirous of learning. Based on his language selection via display unit 50, the reference library 35 transmits an appropriate message to any of the available speech-to-text conversion platforms 60 in order to specify the language in which speech to text conversion service is desired. The display unit 50, in one exemplary embodiment, may be a screen or a CRT monitor with a liquid crystal display (LCD) or a touch interface.

In one exemplary embodiment, the system 100 may use Google as a speech to text conversion API for ease and convenience. Accordingly, the Speech to text API can perform speech recognition directly on an audio file by applying a combination of neural network models and retrieving corresponding translation of content contained within the audio file to a text of a language user wishes to learn.

Drawing from FIG. 1, once the speech in the recorded audio file is recognized by the speech-to-text converting platform 60, appropriate text corresponding to recorded speech is transmitted back to the reference library 35 in a suitable and structured format such as XML or JSON. Upon receiving the JSON text, the library 35 compares the original content contained within the audio file with the received JSON text. Based on this comparison, results are vetted and confidence values are generated by the evaluating unit 80 that are indicative of the extent of accuracy in compared set of texts. For instance, result “1” or “0” may be outputted whereby words that are correctly mapped are indicated in green while the incorrect ones are indicated in red.

Importantly, the evaluating unit 80 performs evaluation based on certain values assigned to each word in a “test line” and also to each such test line. The aggregate here constitutes 100 percentage points of value wherein the score of user is based on correctness of pronouncing these weighted words within each weighted test line.

In one exemplary embodiment, Correlated Occurrence Analogue to Lexical Semantics (COALS) algorithmic approach may be employed to identify the sentences that are semantically equivalent and semantically diverse, that is collectively used to compute the overall score against the predetermined threshold. The approach involves constructing a word-by-word matrix depicting frequency of co-occurrence of one word with another to derive meanings of such semantically and morphologically related word pair.

The components of system 100 shown in FIG. 1 may execute on one or more computer or hardware processors. In one preferred embodiment, the system 100 is configured to mine source code repository e.g. Github to insert source code, preferably Angular 6, therefrom so as to construct a web application framework at the backend and eventually a web application for the end-user to view and interact at the front-end interface or display unit 50.

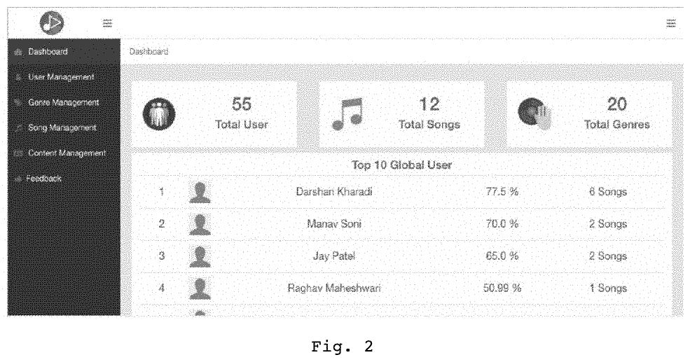

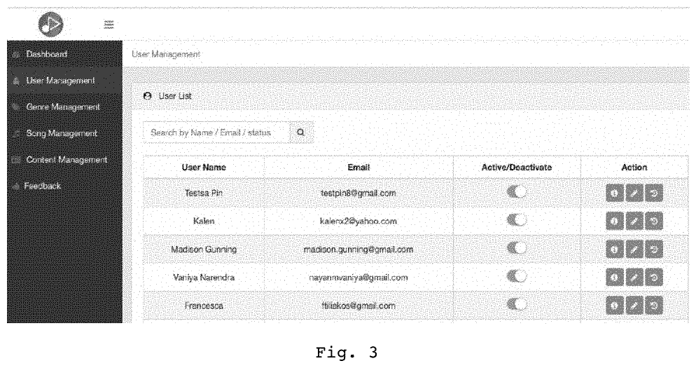

Now, referring to FIG. 2, the web application framework maintained at the backend is illustrated. In one preferred embodiment, the framework primarily provides 5 major areas: a) user management, b) genre management, c) music management, d) content management, and e) feedback. The user management area contains different kinds of registered users who are authorized to activate, deactivate, search, pull up details of any musical composition such as artist, song, duration, clip linked together, and history related therewith. FIG. 3 provides a snapshot of user management area as can be seen by the admin personnel.

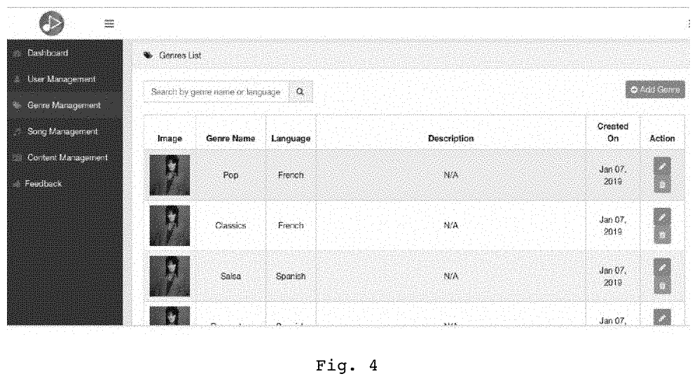

Next, the genre management area refers to a genre of songs that are loosely defined under one category based on similarity of content. Basic genres may include Romance, Hip-Hop, Classical, Sufi, Folk, Dance, Psychedelic, Salsa, and Pop, and so on so forth. The admin personnel here may add, edit, or delete genres from this view. One such illustration is provided in snapshot of FIG. 4.

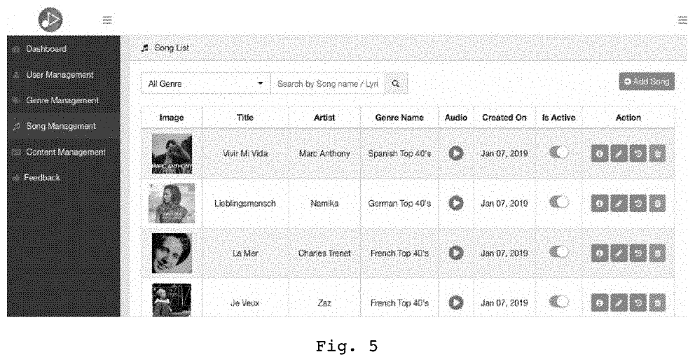

Next in line, the song management area allows the admin to add songs in a particular genre, edit them (may be by adding .SRT files, audio, an image, title, artist, description etc.), delete songs, activate or deactivate and play uploaded audio files for each track; and also view details, history, and lyrics of song, as can be seen in snapshot of FIG. 5.

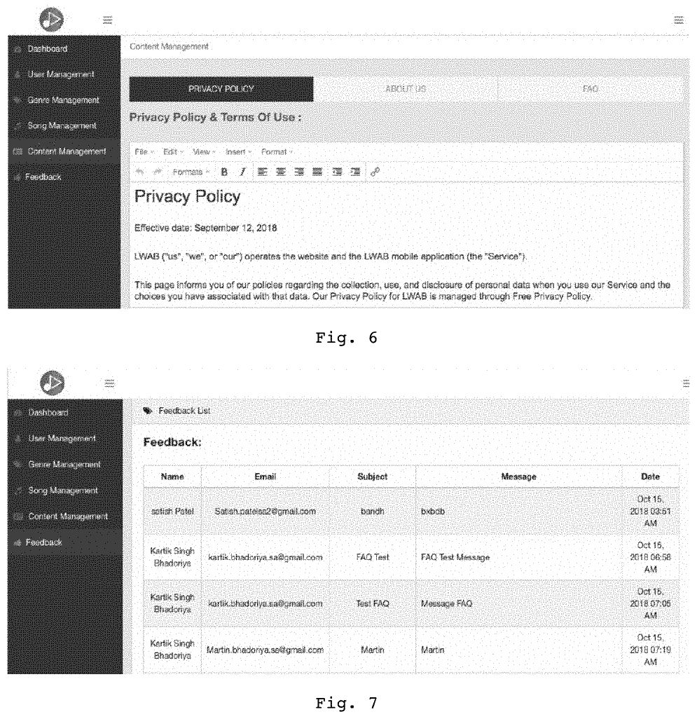

Lastly, the content management area allows the admin to detail out the privacy policy, list down the FAQs and add, amend or delete any content related to “about us” information, as shown in FIG. 6. Also, the feedback tab depicted in FIG. 7 enables one to view and manage feedback provided by an end-user. The entire set of data so extracted is stored in a database and made available over an application server via a network connection. Accordingly, the end-user mobile application communicates over this network connection with the application server to request the populated data therefrom and receive data updates or any configuration changes. It should be understood that multiple mobile end users can communicate with the server.

The database includes a relational database to store application data and related metadata for management and execution of application at the end user device. The application, in one exemplary embodiment, may be executed by inserting node .js from a Github repository. This launches the application on the end user device with a splash screen and one or more frames for app introduction. The end user, at first is requested to login or register on the home page via his email address or via any other app such as Google or Facebook.

Based on the login details, the application page unlocks and user is provided with an option to initiate language-learning process by selecting target language, or can toggle to user profile, genres, their history, the privacy policy, FAQ, feedback or plan upgrade. Further, the user is provided with an option to navigate into a genre for full song list within that genre or by directly clicking on a specific song of choice. Upon drilling into a genre, the user scrolls up and down through a full song list for that genre and is prompted to select a song of choice.

Accordingly, upon making a selection of song, the end user is set to select his native language. He is now prompted to follow instructions laid down on the pop up page. The instructions, may be for example, to follow both original and translated lyrics of the song, repeat the lines after the artist, for use of headphones to have best quality audio. Prior to displaying the list of practice lines, the “song details” API segments the song into time-stamped lines of lyrics (these time-stamped segments correspond to the start/stop times provided within the .SRT files) and also loads the time-stamped audio segments accordingly (such that, when user presses ‘Play’ button on any given practice line, it will only play the audio segment corresponding to those lyrics).

In this fashion, the user interacts with a list of practice lines, which they will be expected to repeat with or after the artist throughout the song. After selecting “Ready to Begin,” the audio will begin to stream from the “song details” API (specifically, via the URL where the audio is stored). Once audio for music track is fully loaded, an audio visualizer is displayed and moves in synchronization with the audio file. In one working embodiment, an in-app counter may be provided that may count for the user as 3. 2.1. i.e. 3 seconds prior to playing of first lyrics so as to ready the user.

In on exemplary embodiment, the lyrics screen may be displayed, with the top half of the screen transmitting the original song lyrics and the bottom half of the screen transmitting lyrics translated into the user's selected native tongue. A series of black text and red text lines may be displayed, line-by-line, synchronized with the song's audio track. Here, only red text lines are considered “test lines” and thus require user to speak/sing with or after the artist to receive line-by-line pronunciation accuracy assessments.

Following from above, the In-app logic scores user based on the total number of words pronounced correctly within all the test lines in the song, and the total score is predicated on the attribution of certain value to each word in a “test line”. In the same way that each word has a certain value within each line, each test line has a certain value, the aggregate of which constitutes 100 percentage points of value, as discussed in previous paragraphs of this description.

The user is given a rating based on the total score received, using the any of the scoring models. For example, a score between 0-50 may refer to an OKAY score, 50-75 may be good, 75-85 may be awesome, 85-99 may be excellent, and 100 can be stated as perfect. A filterable, in-app global/domestic leaderboard may be configured to document and display to the historical user rankings, using the get-ranking API for global data & the get-domestic-ranking API for domestic data. Similarly, a filterable, in-app ‘my history’ leaderboard may document and display historical user performance data using the get-songs-history-app/marks API.

In one exemplary embodiment of present disclosure, the audio recording is played along with display of subtitles for the user to assist in improved learning of foreign language. These subtitles may be stored in different formats, for example, srt format—SubRip program subtitle. The srt file may be created using a library such as “aeneas” to automatically synchronize audio and text of the subtitles, which usually is the lyrics of a musical composition and translation thereof.

The created SRT file is added to a dataset for validation of performance of user. The solution relies on dynamic time warping approach to compare timing of the two time dependent discrete audio segments-one uttered in foreign language in the musical composition and the other of the user who is emulating the song for learning the meaning and usage of the lyrics for purposes of learning the foreign language. The difference in timing of two audio signals is noted for generation of subtitles and eventually comparing speech patterns between the two.

Thus, as mentioned above, the user is facilitated for a personalized language learning session from a musical composition wherein he is allowed to select a music of his own choice and use it to learn a foreign language by reciting the lyrics of song selected. The user is also adjudged based on the accuracy of his pronunciation of words and gets a progress report in real time.

The foregoing description is a specific embodiment of the present disclosure. It should be appreciated that this embodiment is described for purpose of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed is:

1. An easy, cost-effective and play way system for language learning that not only makes the learning process entertaining for user, but interactive as well in real time, comprising:
an easy, play way system for learning a foreign or target language from a musical composition;
an interactive language learning system for training the user to speak and pronounce words in a foreign language appropriately; a standardized method of scoring the user for correctly and accurately pronouncing the words spoken in foreign language such that motivation to perform better and best sustains;
a practical training in real time to learn, understand and imitate usage of foreign language skillfully with continued motivation;
a personalized, cost-effective language learning session is organized for an end user for effective development of his grip on a foreign language.
